(19) United States
(12) Patent Application Publication
(10) Pub. No.: US 2016/0273983 A1
(43) Pub. Date: Sep. 22, 2016

(54) PERFORMANCE SENSING SYSTEM FOR PEDAL POWERED VEHICLES

(71) Applicant: IEE INTERNATIONAL ELECTRONICS & ENGINEERING S.A., Echternach (LU)

(72) Inventors: Stephan GRENGS, Schleid (DE); Jean-Paul SCHMIT, Mersch (LU)

(21) Appl. No.: 14/778,141

(22) PCT Filed: Mar. 18, 2014
(86) PCT No.: PCT/EP2014/055407

§ 371 Date: Sep. 18, 2015

(30) Foreign Application Priority Data
Mar. 18, 2013 (LU) LU 92 170

(51) Int. Cl. G01L 3/24; A43B 5/14; A43B 3/00; G01L 5/22; G01L 1/20

(52) U.S. Cl. CPC G01L 3/24; G01L 5/225; G01L 1/20; A43B 3/0005; A43B 5/14

(57) ABSTRACT

A performance sensing system for a pedal powered vehicle in accordance with the present invention comprises at least one sensor unit for sensing a parameter relating to the power output of a user of said pedal powered vehicle and a processing unit operatively connected to said at least one sensor unit for processing data received from said at least one sensor unit and for storing and/or displaying information relating to the power output generated by the user. According to the invention, the at least one sensor unit is arranged inside an article of footwear of said user, and said at least one sensor unit comprises at least one pressure sensor for detecting a pressure exerted by the user onto a pedal of said pedal powered vehicle.

### TECHNICAL FIELD

The present invention generally relates to the technical field of performance measurement systems for pedal powered vehicles such as road bikes. The invention more specifically relates to a system for real time power measurement in bikes such as road bikes or mountain bikes or the like.

### BACKGROUND ART

A cycling power meter is a device on a bicycle that measures the power output of the rider. Most cycling power meters use strain gauges to measure torque applied, and, combined with angular velocity, calculate power. Power meters using strain gauges are mounted in the bottom bracket, rear freehub, or crankset. Certain newer devices do not use strain gauges and instead measure power through handlebar-mounted units that utilize the principles of Newton's Third Law by measuring a cyclist's opposing forces (gravity, wind resistance, inertia, rolling resistance) and combining these with velocity to determine the rider's power output.

Power meters generally come with a handlebar mounted computer that displays information about the power output generated by the rider such as instantaneous, max, and average power. Most of these computers also serve as all-around cycling computers and can measure and display heart rate as well as riding speed, distance and time.

Different types of power meters are currently on the market.

Crankset power meters measure the torque applied to both pedals via strain gauges positioned within the crank spider. A calculation of power is derived from the deflection of the strain gauges and pedaling cadence. These systems require that the crank allows a certain amount of flex in order for the system to work. However flex in the crank means friction in the material which results in loss of power. Furthermore the system is fixedly mounted to the bike and it requires special tools and skills to mount. It follows that it is hardly possible to transfer the system to another bike. Finally, weighting approximately 1 kg, the system is rather heavy, expensive and cannot distinguish between left or right leg.

A freehub power meter uses the same strain gauges that are present in the crank power meters but are located in the rear wheel hub and measure the power after the drive chain. These systems basically suffer from the same disadvantages than the previously described crankset power meters. Furthermore these systems are subject to additional error sources due to the power transition via chain/losses due to chain and sprockets and finally these systems only allow an average measurement due to a difference on ratio between crank and used gear/sprocket.

Another type of power meters are based on a measurement of chain vibration. At the heart of chain units is essentially a guitar pick-up that mounts to the cycle's chain stay. With this system the pick up detects the chain vibration and speed and mathematically converts it to a power output. As the above described types of power meters, the chain based meter system is fixedly mounted to the bike and it requires special tools and skills to mount. It follows that it is hardly possible to transfer the system to another bike. Furthermore these systems are rather imprecise and unreliable, especially at high outputs, and cannot distinguish between left or right leg.

It follows that the currently available systems for bike performance measurements are either expensive or imprecise. Also they tend to be heavy (a no go) and difficult to mount.

### BRIEF SUMMARY

An improved performance sensing system for pedal powered vehicles is provided herein which alleviates at least some of the above disadvantages.

The present invention generally relates to a bike performance measurement system which comprises at least one film-type pressure sensor and which is configured for being arranged in a bike shoe. Preferably, the system includes a communication interface for communicating with a bike computer or other hardware. An aspect of the invention relates to a bike shoe, comprising a bike performance measurement system based on one or more film-type pressure sensors.

A performance sensing system for a pedal powered vehicle in accordance with the present invention comprises at least one sensor unit for sensing a parameter relating to the power output of a user of said pedal powered vehicle and a processing unit operatively connected to said at least one sensor unit for processing data received from said at least one sensor unit and for storing and/or displaying information relating to the power output generated by the user. According to the invention, the at least one sensor unit is arranged inside an article of footwear of said user, and said at least one sensor unit comprises at least one pressure sensor for detecting a pressure exerted by the user onto a pedal of said pedal powered vehicle.

In contrast to the prior art power measurement devices, the system according to the present invention comprises a sensor unit which is mounted or arranged in an article of footwear, typically a bike shoe, of the user of the pedal powered vehicle. This means that the system is not installed on the bike itself and accordingly is easily transferrable to another bike. Furthermore the system is not depending on flexibility of the crank or pedal of the bike.

In a preferred embodiment of the invention, said at least one sensor unit comprises an electronic control module operatively coupled to said pressure sensor, wherein said electronic control module is configured for recording sensor data and transmitting the data recorded by said sensor unit to said processing unit. In such an embodiment the processing unit received the “raw” data of the sensor unit and performs the computing of the interesting values regarding power deployment.

In an alternative embodiment, the at least one sensor unit comprises an electronic control module operatively coupled to said pressure sensor, and wherein said electronic control module is configured for recording sensor data, computing interesting values regarding power deployment from said sensor data and transmitting the interesting values regarding power deployment to said processing unit. In such an embodiment, the processing unit does not necessarily compute further interesting values from the received data. Instead the processing unit may only perform the storing and displaying of the interesting values regarding power deployment.

In both of the above described embodiments, the electronic control module is operatively coupled to said processing unit by a wireless connection link, preferably using a widely used protocol such as ANT+. It will be noted that the processing unit may be a part of a cycling computer mounted on the pedal, powered vehicle or a smart phone or the like.

In a preferred embodiment of the invention, the at least one sensor unit is removably arranged in a sole structure of the article of footwear. The sensor is preferably positioned precisely in the area where the power is transferred through the sole into the pedal.

In a preferred embodiment, the article of footwear is a bike shoe, and at least one sensor unit is arranged in each of a left shoe and a right shoe. This embodiment enables an individual evaluation of the power deployed by the right and left leg and thus a determination of the individual performance of each leg.

In order to detect whether a pedal is in motion or other parameters relating to pedal movement, the at least one sensor unit of the performance sensing system preferably comprises at least one G-force sensor. This G-force sensor is preferably operatively coupled to the electronic control module and enables to gather information about whether the pedal is in motion or not, about the pedal cadence or the like.

In an advantageous embodiment of the invention, the said pressure sensor is a film-type pressure sensor comprising a first carrier foil and a second carrier foil arranged one above the other at a certain distance by means of a spacer provided with at least one opening and an electrode arrangement with at least two electrodes arranged so that an electrical contact is established between the electrodes if said first and second carrier foils are brought together in response to a pressure acting on said pressure sensor. These film type pressure sensors are very reliable and easy to integrate into the shoe sole.

The pressure sensor preferably comprises one or more pressure-sensing cells, each of said pressure sensing cells comprising a first flexible carrier film and a second flexible carrier film, said first and second carrier films being attached to one another by a spacer film having an opening, a first electrode arranged on said first carrier film and a second electrode arranged on said second carrier film, said first and second electrodes being arranged in facing relationship with each other in said opening in such a way that said first and second electrodes may be brought into contact with each other when pressure is exerted on said pressure-sensing cell and that a contact area between said first and second electrode increases with increasing pressure. The individual pressure cells may be suitably arranged in the sole at those locations, at which the power is transferred through the sole into the pedal.

The above described shoe sensor offers the possibility to directly measure pressure (force) over time. From this one can compute the power applied while pedaling since the crank arm length is known. The needed angular velocity is given by an optional G-sensor or even due to the timing of the cell activation.

The power performance during the lifting phase is calculated by the software with correction factors. The correction factors are chosen by the software depending on the force still applied to the sensor or even zero force if the cyclist is really pulling during the lifting phase. The pressure profiles also enable the system to calculate the performance of each leg. Current smartphones and training computers support ANT+ for communication so the system could hook up with existing hardware and community based evaluation websites (e.g. Garmin Connect).

### BRIEF DESCRIPTION OF THE DRAWINGS

Preferred embodiments of the invention will now be described, by way of example, with reference to the accompanying drawings, which show:

FIG. 1: a schematic view of a rider of a bike equipped with an embodiment of a power measurement system according to the present invention;

FIGS. 2 & 3: the arrangement of the sensor unit in a bike shoe,

FIG. 4: a schematic cross sectional view of a pressure sensor, and

FIG. 5: a diagram showing some of the calculations which may be performed by the power measurement system.

### DESCRIPTION OF PREFERRED EMBODIMENTS

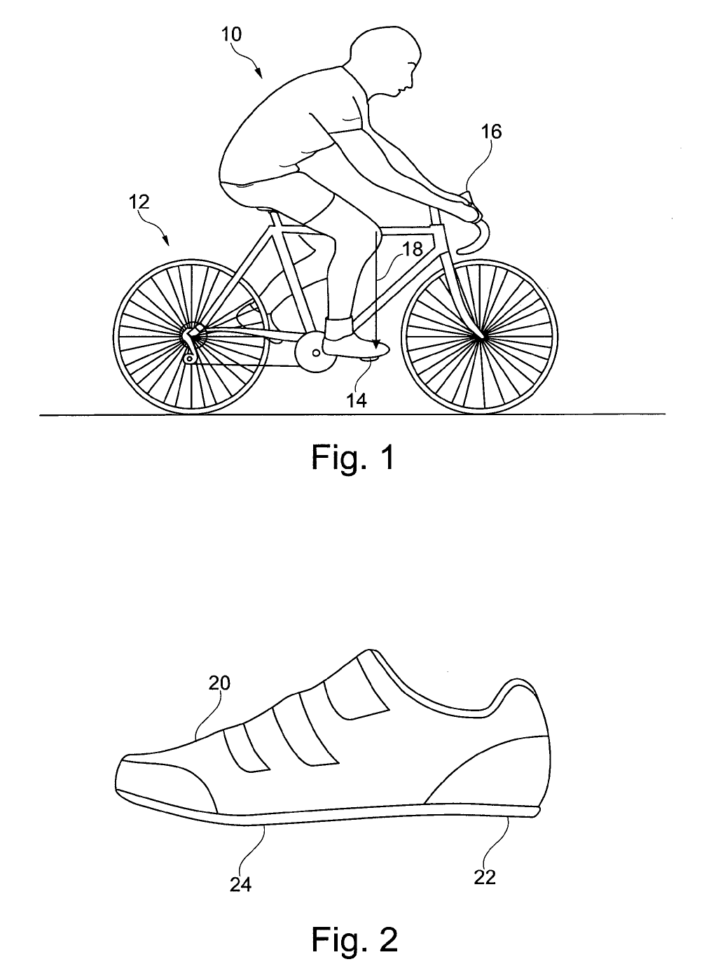

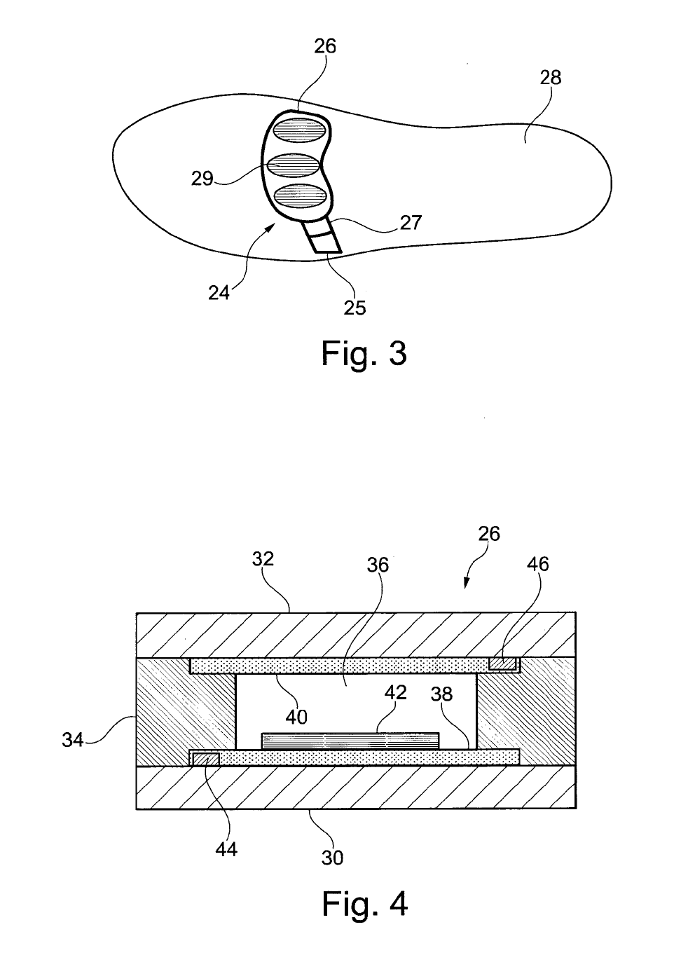

FIG. 1 shows a schematic view of a rider 10 of a bike 12 equipped with an embodiment of a power measurement system according to the present invention. The power measurement system mainly comprises a sensor unit integrated into the shoe of the bike (generally shown as 14) and a processing module integrated for instance in the cycling computer 16, which may be mounted on a handlebar of the bike. The sensor unit, which is preferably operatively connected to the processing module via a wireless link, is configured for determining the pressure applied to the pedal (the direction of the applied pressure is generally shown by the arrow 18) and preferably for determining motion e.g. by means of a G-force sensor.

An important aspect of the present invention comprises a pressure sensor integrated into the shoe of the biker to be used as a device that enables cyclists to generate power measurements on pedal powered vehicles. The shoe generally comprises the shoe upper 20 which is mounted on the shoe sole structure 22 (see also FIG. 2), generally a multilayered structure with an insole, a midsole and an outsole. Cleats may optionally be attached to the outsole in a power transfer area 24 towards the pedal.

In a preferred embodiment, the pressure sensor is a polymer film based pressure sensor mat 26. FIG. 3 schematically shows the arrangement of a pressure sensor mat 26 in the power transfer area 24 of the shoe. The pressure sensing mat is preferably removably integrated into the insole 28 of the sole structure. The pressure sensor mat is provided with an electronic control module 25, which is operatively coupled to the pressure sensor mat 26 by means of the connection tab 27. The electronic control module 25 is e.g. configured for recording sensor data, computing interesting values regarding power deployment from said sensor data and transmitting the interesting values regarding power deployment to said processing unit.

As best shown in FIG. 3, the pressure sensor 26 comprises a plurality of pressure-sensing cells 29 located in the power transfer area 24 of the sole structure, for measuring pressure exerted by the wearer's foot on the sole structure. The pressure sensor generally comprises a multilayered structure including a first carrier film 30, a second carrier film 32, and a spacer 34. The spacer 34 is typically a double-sided adhesive, with which the first and second carrier films 30, 32 are laminated together.

The first and second carrier films 30, 32 are preferably made of PET but other materials such as PEN, PI, PEEK etc. are also possible. Each of the carrier films may comprise a single film layer or comprise a plurality of film layers of the same or different materials. The spacer 34 preferably comprises a PET, PEN, PI, PEEK, etc. film layer with an adhesive coating applied on each side thereof. At each pressure-sensing cell 29, the spacer comprises an oblong opening 36, within which the first and second carrier films 30, 32 may be pressed together. In each pressure-sensing cell 29, a first resistive electrode 38 is permanently arranged on the first carrier film 30 and a second resistive electrode 40 is permanently arranged on the second carrier film 32, in facing relationship with the first electrode 38. Each electrode 38, 40 is contacted by a respective strip conductor 44, 46, which run alongside the long sides of the opening 36. At least one of the electrodes 38, 40 (in this example: electrode 38) may be partially covered with an electrically insulating layer 42 (e.g. a dielectric layer).

In response to pressure acting on the pressure-sensing cell, at least one of the first and second carrier films 30, 32, deflects towards the other carrier film until the carrier films 30, 32 or the elements on their respective surface come into contact. Once contact is established, the radius of the mechanical contact surface increases with increasing pressure. When a direct contact is established between the electrodes 38 and 40, the electrical resistance between the conductors 44 and 46 becomes finite and a current may flow in consequence. As the contact area between the first and second electrodes 38, 40 increases, the resistance measurable between the conductors 44 and 46 decreases. The positions of the contacts between the resistive electrodes 38, 40 and the respective strip conductor 44, 46, the specific resistance of the resistive electrodes, and the shape of the electrically insulating layer 42 determines the pressure-dependent cell resistance.

The electrical response function of the pressure-sensing cells, i.e. the resistance versus pressure, may be adjusted in a predetermined manner by suitably shaping the insulating layer 42, because the electrically insulating layer 42 locally prevents a direct contact between the first and second electrodes 38, 40 whereas the direct contact is possible in those areas where the electrically insulating layer 42 is absent. The other parameters of the pressure-sensitive cells, e.g. the materials of the electrodes, need not be adapted.

The sensor mat, comprising an array of especially designed and positioned sensor cells, is used to gather information about the pressure applied on certain areas of the shoe sole over time. The sensor cell array should be positioned precisely in the area where the power is transferred through the sole into the pedal. The cells have to be designed so that they do not run into saturation even when high forces are exerted to the pedals.

The power values of interest are the values exerted on the pedals. From these power values a number of interesting performance information may be calculated. Various correction factors may be included in the system software (e.g.: uneven cell activation due to bad foot positioning or lack of active pull force during the pedal lifting phase).

With the optional G-Force sensor (a 1-axis G-force sensor or a 3-axis G-force sensor), the system may gather the following information:
whether the pedal is in motion or not
pedal cadence (this is more accurate than the elapsing time between sensor cell activation)
power generated during the lifting phase
crank position during pedal motion
Cyclist standing on pedal e.g. during downhill

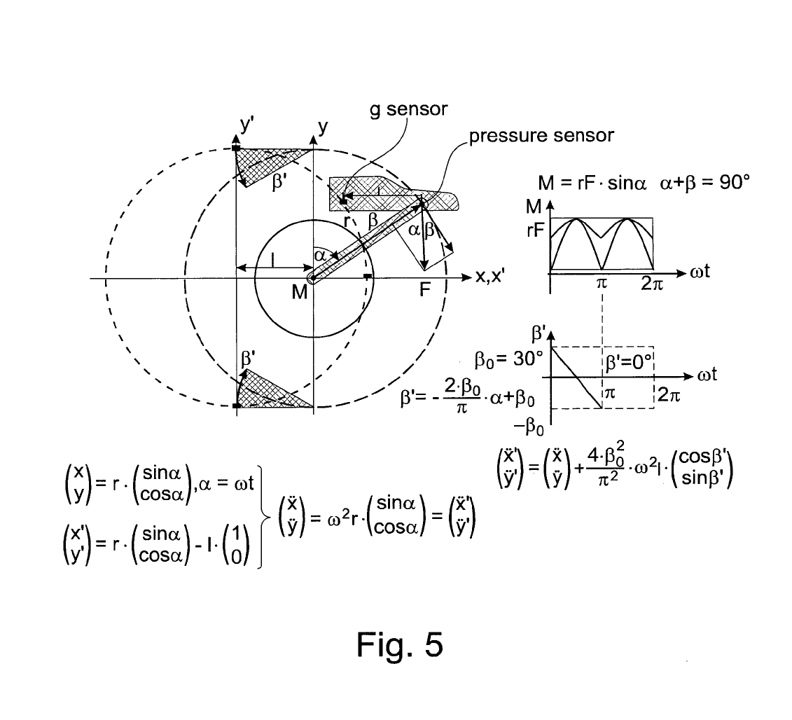

With the data from the sensor mat and the G-force sensor the system can compute (see also FIG. 5):
Current power→Pᵣₒₜ=M*ω where M=F*r (F is measured; crank radius is known; ω is calculated by the system as the time for one rotation cycle is measured; the 3 axis G-force sensor can be used to obtain information about the pedal position during the rotation to enable vector calculations \vec{M}=\vec{r}×\vec{F})
peak power→max Pᵣₒₜ
average power
power value split left/right leg
cadence→signal G-sensor or TOP activations per time unit
rolling period power
Total energy→W/s, Joule
Overlay of power values and GPS map data (depends on cycling computer) which enables the cyclist to see what power values were recorded at which location of the covered route.
Real time monitoring power left/right
Round cycling motion (‘runder Tritt’)

In combination with a bicycle computer or a smart phone the readings become accessible to the cyclist for immediate information or later use in training software. Communication between the sensor/ECU and the cycling computer/smart phone should take place via a widely used protocol (e.g.: ANT+) in order to be compatible to other devices.

1. A performance sensing system for a pedal powered vehicle, comprising:
at least one sensor unit configured for sensing a parameter relating to a power output of a user of said pedal powered vehicle; and
a processing unit operatively connected to said at least one sensor unit and configured for processing data received from said at least one sensor unit and configured for storing and/or displaying information relating to the power output generated by the user,
wherein said at least one sensor unit is arranged inside an article of footwear of said user, and
wherein said at least one sensor unit comprises at least one pressure sensor for detecting a pressure exerted by the user onto a pedal of said pedal powered vehicle.

2. The performance sensing system according to claim 1, wherein said at least one sensor unit comprises an electronic control module operatively coupled to said pressure sensor, said electronic control module being configured for recording sensor data and transmitting the data recorded by said sensor unit to said processing unit.

3. The performance sensing system according to claim 1, wherein said at least one sensor unit comprises an electronic control module operatively coupled to said pressure sensor, said electronic control module configured for recording sensor data, computing interesting values regarding power deployment from said sensor data and transmitting the interesting values regarding power deployment to said processing unit

4. The performance sensing system according to claim 2, wherein said electronic control module is operatively coupled to said processing unit by a wireless connection link

5. The performance sensing system according to claim 1, wherein said at least one sensor unit is arranged in a sole structure of the article of footwear.

6. The performance sensing system according to claim 1, wherein said article of footwear is a bike shoe, and wherein at least one sensor unit is arranged in each of a left shoe and a right shoe.

7. The performance sensing system according to claim 1, wherein said at least one sensor unit further comprises at least one G-force sensor.

8. The performance sensing system according to claim 1, wherein said pressure sensor is a film-type pressure sensor comprising a first carrier foil and a second carrier foil arranged one above the other at a certain distance by means of a spacer provided with at least one opening and an electrode arrangement with at least two electrodes arranged so that an electrical contact is established between the electrodes if said first and second carrier foils are brought together in response to a pressure acting on said pressure sensor.

9. The performance sensing system according to claim 1, wherein said pressure sensor comprises one or more pressure-sensing cells, each of said pressure sensing cells comprising a first flexible carrier film and a second flexible carrier film, said first and second carrier films being attached to one another by a spacer film having an opening, a first electrode arranged on said first carrier film and a second electrode arranged on said second carrier film, said first and second electrodes being arranged in facing relationship with each other in said opening in such a way that said first and second electrodes may be brought into contact with each other when pressure is exerted on said pressure-sensing cell and that a contact area between said first and second electrode increases with increasing pressure.

10. The performance sensing system according to claim 9, wherein each of said pressure sensing cells is oval, elliptical or rectangular with rounded angles.
